(19) United States
(12) Patent Application Publication
(10) Pub. No.: US 2005/0178883 A1
(43) Pub. Date: Aug. 18, 2005

(54) Helicopter tail rotor pylon

(76) Inventors: Alan Roy Goodworth, Oxford, CT (US); Bruce Frederic Kay, Milford, CT (US)

Correspondence Address: BACHMAN & LAPOINTE, P.C., 900 CHAPEL STREET, SUITE 1201, NEW HAVEN, CT, 06510, US

(21) Appl. No.: 10/755,051

(22) Filed: Jan. 8, 2004

(51) Int. Cl. B64C 27/00

(52) U.S. Cl. 244/17.11

(57) ABSTRACT

In accordance with the present invention, a tail rotor pylon for use on a rotorcraft, such as a helicopter, is provided. The tail rotor pylon has a plurality of elements formed from a carbon/epoxy composite material. These elements include side skin panels, ribs, and spars.

### BACKGROUND OF THE INVENTION

The present invention relates to the construction of a tail rotor pylon for a helicopter.

Various types of rotorcraft, such as helicopters, have a pylon at a tail end of the fuselage for supporting a tail rotor. These tail rotor pylons undergo a wide variety of forces which impact the service life of the pylons. Even with the many improvements which have been made to helicopters, there remains a need for a better tail rotor pylon which has an improved service life and which is lighter in weight than current tail rotor pylons without any sacrifice in performance.

### SUMMARY OF THE INVENTION

Accordingly, it is an object of the present invention to provide an improved tail rotor pylon construction which has an improved service life.

It is a further object of the present invention to provide an improved tail rotor pylon construction which effects a weight savings.

The foregoing objects are attained by the tail rotor pylon of the present invention.

In accordance with the present invention, a tail rotor pylon for use on a rotorcraft is provided. The tail rotor pylon has a plurality of elements formed from a carbon/epoxy composite material. These elements include side skin panels, ribs, and spars.

Other details of the helicopter tail rotor pylon of the present invention, as well as other objects and advantages attendant thereto, are set forth in the following detailed description and the accompanying drawing wherein like reference numerals depict like elements.

### BRIEF DESCRIPTION OF THE DRAWINGS

FIG. 1 illustrates a helicopter having a tail rotor pylon;

FIG. 2 illustrates the basic structural arrangement for a composite tail rotor pylon in accordance with the present invention;

FIG. 3 illustrates the features of a composite tail rotor pylon in accordance with the present invention;

FIG. 4 illustrates a discrete stiffened construction;

FIG. 5 illustrates a bead stiffened construction;

FIG. 6 illustrates a sandwich stiffened construction;

FIG. 7 illustrates a plug-in metal fitting construction; and

FIG. 8 illustrates a composite fitting construction.

### DETAILED DESCRIPTION OF THE PREFERRED EMBODIMENT(S)

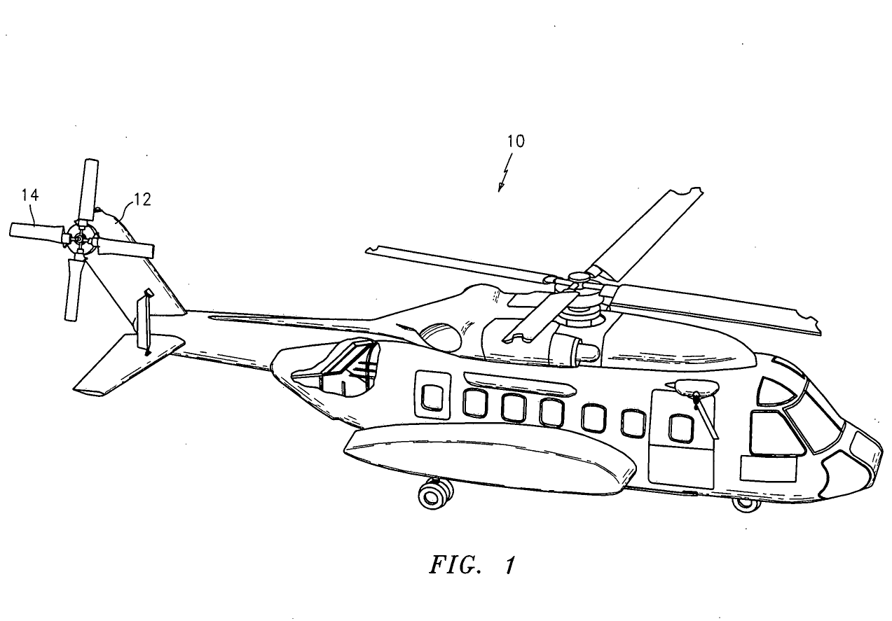

Referring now to the drawings, FIG. 1 illustrates a helicopter 10 having a tail rotor pylon 12 and a tail rotor 14 mounted to the pylon. The tail rotor 14 may be driven through any suitable drive arrangement known in the art.

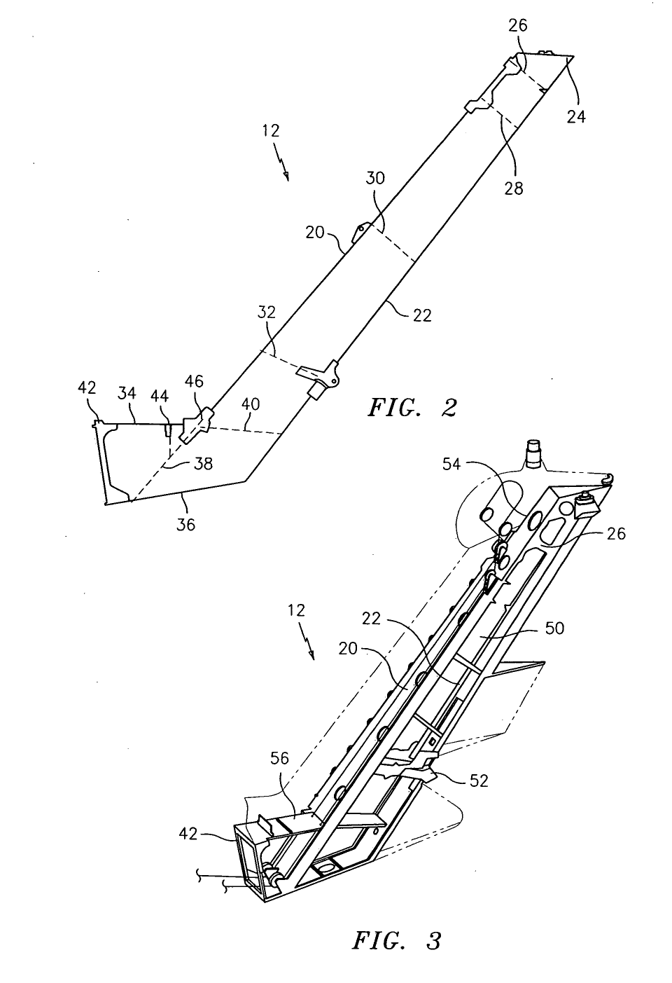

FIG. 2 illustrates the basic structural arrangement of the composite tail rotor pylon 12 of the present invention. As shown therein, the pylon 12 includes a forward spar 20 and an aft spar 22 spaced from the forward spar 20. A number of ribs extend between the spars 20 and 22 and are connected thereto. These ribs include a tip rib 24, gear box support ribs 26 and 28, a stabilator actuator rib 30, and a stabilator attachment rib 32. The pylon 12 further has an upper shear deck 34 attached to the forward spar 20 and a lower shear deck 36 which extends between a forward spar extension 38 and the aft spar 22. An upper shear deck extension 40 extends between the forward spar 20 and the aft spar 22. The pylon 12 further has a fold frame 42 attached to the upper shear deck 34 and the lower shear deck 36 and a plurality of gear box supports 44 and 46.

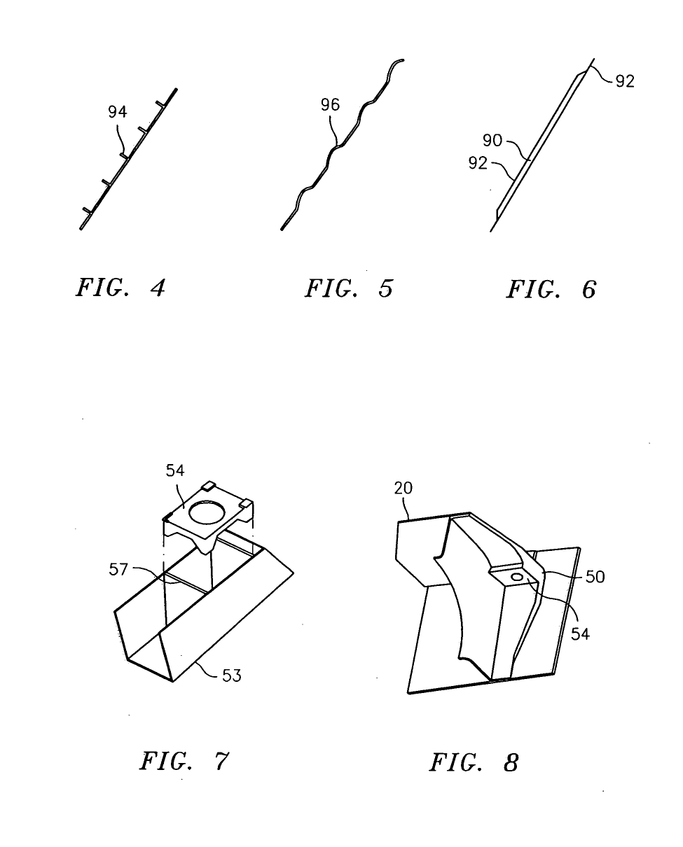

In order to provide an extended service life without sacrificing strength and performance and in order to gain weight savings, it has been found desirable to form various components of the tail rotor pylon 12 from non-traditional materials. For example, the forward and aft spars 20 and 22 are each preferably formed from an integrally stiffened carbon/epoxy material. An integrally stiffened carbon/epoxy material is one which have stiffening elements, i.e. blade stiffeners, beads, sandwich core, etc., co-cured with the part without secondary assembly. FIGS. 4-6 illustrate different types of stiffening constructions which may be employed. Thus, as shown in FIG. 6, the carbon/epoxy material could be a composite having a core 90 with two face sheets 92 attached to it. The core could be a KEVLAR or NOMEX honeycomb core material or a carbon pin truss type core. Each of the face sheets can be formed from a carbon-epoxy fabric and/or a carbon-epoxy tape. It is preferred that the carbon/epoxy material be a toughened resin system. FIG. 4 illustrates a discrete stiffened component in which discrete stiffening elements 94 form part of the structure. FIG. 5 illustrates a bead stiffened component in which a plurality of integrally formed beads 96 provide a desired level of stiffness.

The spars 20 and 22 may have integral fairing attach angles. To do this, the side skins of the spar box formed by the spars 20 and 22 extend forward and aft to provide an attachment feature for removable leading and trailing edge fairings.

The ribs 24, 26, 28, and 32, if desired, may each be formed from an integrally molded carbon/epoxy material. The material may have the same construction as the material used for the spars 20 and 22.

The pylon 12 has side skins 50 attached to both sides of the spars 20 and 22. In a preferred embodiment, each of the side skins 50 is also formed from an integrally stiffened carbon/epoxy material. The stiffening may be provided by using a sandwich construction or discrete stiffening. If desired, the side skins may have doubler plies and/or other reinforcements that are molded integrally with the skins 50 and that permit ease of assembly or retractable tubular steps.

The pylon 12 also includes an intermediate stabilator fitting 52 attached to the aft spar 22. The fitting 52 may be formed from an integral composite material such as a carbon/epoxy material similar to the one used for the side skins 50 or from a metallic material such as machined aluminum.

A tail rotor gearbox fitting 54 is attached to an upper portion of the forward and aft spars 20 and 22. The gearbox fitting may be formed from a composite material such as a carbon/epoxy composite material or from a metallic material such as machined aluminum. As shown in FIG. 7, the fitting 54 may be plugged into a cocured pylon box 53 with integral ribs 55. Alternatively, as shown in FIG. 8, the fitting 54 may be formed from a composite material and attached to the pylon at the intersection of a side skin 50 and the forward spar 20.

An intermediate gearbox fitting 56 is joined to the upper shear deck 34. The gearbox fitting 56 may be formed from a composite material such as a carbon/epoxy composite material of the type discussed hereinbefore or from a metallic material such as machined aluminum.

Similarly, the attachment frame 42 with the fold hinges, known as the fold frame, may be formed from a composite material such as a carbon/epoxy composite material of the type discussed hereinbefore or from a metallic material such as machined aluminum.

One advantage to the pylon construction of the present invention is that it may be built in various ways. Pylon skins can be fiber placed or hand layed-up over a sandwich core. Ribs and composite fittings can be built using resin transfer molding or basic prepeg lay-up. The pylon can be assembled from multiple procured pieces including two halves with a lap joint or be a three sided box with removable forward spar and shear deck. The pylon may also be a two piece box structure having removable skin panels.

It is apparent that there has been provided in accordance with the present invention a helicopter tail rotor pylon which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

1. A tail rotor pylon for use on a rotorcraft, said tail rotor pylon having a plurality of components formed from a carbon/epoxy composite material.

2. A tail rotor pylon in accordance with claim 1, wherein said plurality of components includes a plurality of integrally molded carbon/epoxy ribs.

3. A tail rotor pylon in accordance with claim 1, wherein said plurality of components includes a side skin panels formed from said carbon/epoxy composite material.

4. A tail rotor pylon in accordance with claim 3, wherein said side skin panels are integrally stiffened.

5. A tail rotor pylon in accordance with claim 4, wherein said side skin panels have discrete stiffening members.

6. A tail rotor pylon in accordance with claim 3, wherein said side skin panels have a sandwich construction.

7. A tail rotor pylon in accordance with claim 1, further comprising a metal tail rotor gearbox fitting.

8. A tail rotor pylon in accordance with claim 1, further comprising a tail rotor gearbox fitting formed from a composite material.

9. A tail rotor pylon in accordance with claim 1, further comprising a plurality of spars formed from an integrally stiffened carbon/epoxy material.

10. A tail rotor pylon in accordance with claim 9, wherein each of said spars has a sandwich construction.

11. A tail rotor pylon in accordance with claim 9, wherein each of said spars has a plurality of discrete stiffening members.

12. A tail rotor pylon in accordance with claim 9, wherein each of said spars has beaded stiffeners.

13. A tail rotor pylon in accordance with claim 1, further comprising an intermediate gearbox fitting formed from at least one of a metallic material and a composite material.

14. A tail rotor pylon in accordance with claim 1, further comprising an attachment frame formed from at least one of a metallic material and a composite material.

15. A tail rotor pylon in accordance with claim 14, wherein said attachment frame has fold hinges.

16. A tail rotor pylon in accordance with claim 1, further comprising an intermediate stabilator fitting formed from at least one of a metallic material and a composite material.

17. A tail rotor pylon for use on a rotorcraft, said tail rotor pylon having a plurality of components formed from a carbon/epoxy composite material and said components including a plurality of integrally molded carbon/epoxy ribs, side skin panels formed from said carbon/epoxy composite material, and a plurality of spars formed from an integrally stiffened carbon/epoxy material.

18. A tail rotor pylon according to claim 17, further comprising a tail rotor gearbox fitting, an intermediate gearbox fitting formed from at least one of a metallic material and a composite material, an attachment frame formed from at least one of a metallic material and a composite material, and an intermediate stabilator formed from at least one of a metallic material and a composite material.

19. A tail rotor pylon according to claim 18, wherein said attachment frame has fold hinges.
